(19) United States
(12) Patent Application Publication
(10) Pub. No.: US 2007/0245359 A1
(43) Pub. Date: Oct. 18, 2007

(54) Communication control apparatus, communication control program, and communication driver registration method

(75) Inventors: Tomoya Yamazaki, Maebashi-shi (JP); Tatsuya Takasugi, Maebashi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: FUJITSU LIMITED, Kawasaki (JP); FUJITSU FRONTECH LIMITED, Inagi-shi (JP)

(21) Appl. No.: 11/510,559

(22) Filed: Aug. 28, 2006

(30) Foreign Application Priority Data
Mar. 30, 2006 (JP) 2006-092923

(51) Int. Cl. G06F 9/46

(52) U.S. Cl. 719/321

(57) ABSTRACT

The present invention has been made to provide a communication control apparatus, a communication control program, and a communication driver registration method allowing communication between an application supporting a predetermined connection method and a peripheral device supporting a different connection method from that of the application. An information processing apparatus 310 includes a pseudo VCOM port driver 371 that supplies a first handle that an application 153 running on the information processing apparatus 310 uses for communication with a peripheral device 230; and a pseudo PnP filter 371 that acquires a second handle used for operation of a VCOM port driver 261 when receiving notification indicating that the peripheral device 230 is connected to a USB interface 212 of the information processing apparatus 310 and, when receiving a request made using the first handle from the application 153, uses the second handle to send the request to the VCOM port driver 261.

### BACKGROUND OF THE INVENTION

1. Field of the Invention

The present invention relates to a communication control apparatus connected to peripheral devices via a communication interface, a communication control program, and a communication driver registration method.

2. Description of the Related Art

POS (Point Of Sales system) terminals developed in recent years are designed as an information processing apparatus in which an OS (Operation System) is running. Such a POS terminal has a communication interface and is connected to peripheral devices such as a scanner, a keyboard, and a monitor so as to communicate with them. RS-232C (Recommended Standard 232 version C) connection is mainly used in communication between a conventional POS terminal and peripheral devices.

A conventional communication system using RS-232C connection will be described below.

Firstly, a configuration of a conventional communication system using RS-232C connection will be described.

FIG. 5 is a block diagram showing an example of the configuration and operation of a conventional communication system using RS-232C connection. An information processing apparatus 110 serving as a POS terminal or the like includes, as hardware components, a controller 111 and an RS-232C interface 112. A peripheral device 130 includes, as hardware components, a controller 131 and an RS-232C interface 132. The RS-232C interfaces 112 and 132 are connected to each other by an RS-232C cable. The controllers 111 and 131 are realized by a CPU (Central Processing Unit) and a storage device (memory or the like).

The controller 111 includes, as software components, an OS (Operating System) 151, a driver 152 compatible with the peripheral device 130 and RS-232C interface 112, and an application 153 designed for RS-232C connection. The driver 152 includes a COM port driver 161. The COM port driver 161 is a function provided by the OS 151.

Operation of the conventional communication system using RS-232C connection will next be described.

The COM port driver 161 is previously registered in the OS 151 in association with the RS-232C interface 112, and a COM port number is assigned thereto. This registration allows the OS 151 to generate the COM port driver 161 during its start-up process. The COM port number is previously set as a COM port number for communicating with the peripheral device 130 in the application 153.

The OS 151 generates the previously registered COM port driver 161 during its startup process (S111). Afterward, the COM port driver 161 is resident in the controller 111. Subsequently, the application 153 performs open processing for the COM port driver 161 according to a previously set COM port number (S112) and then COM port driver 161 notifies the application 153 of a COM port control handle (S113).

The application 153 then uses the COM port control handle to make an access request (S121). The COM port driver 161 receives the request, accesses the peripheral device 130 via the RS-232C interface 112 (S122), and notifies the application 153 of an access result such as a normal reply or an error reply (S123). If the peripheral device 130 is disconnected from the RS-232C interface 112, the COM port driver 161 notifies the application 153 of an error replay.

Meanwhile, along with recent popularization of USB (Universal Serial Bus), USB connection has come to be used for connection between a POS terminal and peripheral devices.

In the following, a conventional communication system using USB connection will be described.

Firstly, a configuration of a conventional communication system using USB connection will be described.

FIG. 6 is a block diagram showing an example of the configuration and operation of a conventional communication system using USB connection. An information processing apparatus 210 serving as a POS terminal or the like includes, as hardware components, a controller 211 and a USB interface 212. A peripheral device 230 includes, as hardware components, a controller 231 and a USB interface 232. The USB interfaces 212 and 232 are connected to each other by a USB cable. The controllers 211 and 231 are realized by a CPU and storage device (memory or the like) like the controllers 111 and 131 described above.

The controller 211 includes, as software components, an OS 151 (same as one shown in FIG. 5), a driver 252 compatible with the peripheral device 230 and USB interface 232, and an application 253 designed for USB connection. The drive 252 includes a VCOM port (virtual COM port) driver 261. The VCOM port driver 261 is realized by using a function provided by the OS 151 and allows the USB interface 232 as a virtual COM port having the same function as that of a COM port. The VCOM port driver 261 may be designed in accordance with the specification of the peripheral device 230.

Operation of the conventional communication system using USB connection will next be described.

The VCOM port driver 261 is registered in the OS 151 at install time of the driver 252. This registration allows the OS 151 to generate the VCOM port driver 261 when the peripheral device 230 is connected to the USB interface 212.

The OS 151 determines whether a state (interface state) of the USB interface 212 is a state in which the peripheral device 230 is connected thereto (connection state) or a state in which the peripheral device 230 is disconnected therefrom (disconnection state). Every time the state changes, the OS 151 generates an event indicating the change of the state. The application 253 monitors the event sent from the OS 151 to determine whether the peripheral device 230 is connected to the USB interface 212 of the information processing apparatus 210.

When the peripheral device 230 is connected to the USB interface 212, the OS 151 generates an event indicating the connection state (S211) as well as the previously registered VCOM port driver 261 (S212). At this time, the OS 151 assigns an unused COM port number to the VCOM port driver 261 as a virtual COM port number.

The application 253 recognizes the connection state based on the event sent from the OS 151, performs open processing for the VCOM port driver 261 (S231), and acquires a VCOM port driver control handle from the VCOM port driver 261 (S232).

The application 253 uses the VCOM port driver control handle to make an access request (S241). The VCOM port driver 261 receives the request and accesses the peripheral device 230 via the USB interface 212 (S242).

If the peripheral device 230 is disconnected from the USB interface 212, the OS 151 generates an event indicating the disconnection state and deletes the VCOM port driver 261. When recognizing the disconnection state based on the event sent from the OS 151, the application 253 does not make an access to the peripheral device 230.

As a prior art related to the present invention, there is known an information processing apparatus including a USB interface, which can also connect with a peripheral device provided with an interface other than the USB interface (refer to, for example, Jpn. Pat. Appln. Laid-Open Publication No. 11-266315).

The abovementioned communication systems using RS-232C connection and USB connection differ from each other in the following point.

In the case of RS-232C connection, the application 153 cannot recognize the interface state and accordingly makes an access to the peripheral device 130 without regard for the interface state. Further, the access result is notified from the COM port driver 161 to the application 153.

In the case of USB connection, the application 253 can recognize the interface state and makes an access to the peripheral device 230 only when the interface state is the connection state. The access result is not notified from the VCOM port driver 261 to the application 253. Even if the configuration of the application 253 is changed such that it makes an access to the peripheral device 230 irrespective of the interface state, the VCOM port driver 261 is deleted by the OS 151 when the interface state is changed to the disconnection state.

Therefore, in order to make software resources designed for peripheral devices of RS-232C connection type correspond to peripheral devices of USB connection type, it has been necessary to significantly modify the software resources.

### SUMMARY OF THE INVENTION

The present invention has been made in view of the above problem, and an object thereof is to provide a communication control apparatus, a communication control program, and a communication driver registration method allowing communication between an application supporting a predetermined connection method and a peripheral device supporting a different connection method from that of the application.

To solve the above problem, according to a first aspect of the present invention, there is provided a communication control apparatus that is connected to a peripheral device via a communication interface and communicates with the peripheral device, comprising: a first handle supply section that supplies a first handle that an application running on the communication control apparatus uses for communication with the peripheral device to the application; and a relay section that acquires a second handle used for operation of a communication interface driver which is the driver of the communication interface when receiving notification indicating that the peripheral device is connected to the communication interface and, when receiving a request made using the first handle supplied by the first handle supply section from the application, uses the second handle to send the request to the communication interface driver.

The communication control apparatus according to the present invention further comprises a communication interface state notification section that notifies the relay section that the peripheral device is connected to the communication interface.

In the communication control apparatus according to the present invention, the communication interface state notification section notifies the relay section that the peripheral device is disconnected from the communication interface.

In the communication control apparatus according to the present invention, in the case of receiving an access made using the first handle supplied by the first handle supply section after receiving the notification that the peripheral device is disconnected from the communication interface, the rely section notifies the application of an error reply.

In the communication control apparatus according to the present invention, the first handle supply section and relay section are resident in the communication control apparatus, and the communication interface driver and communication interface state notification section exist in the communication control apparatus only while the peripheral device is connected to the communication interface.

In the communication control apparatus according to the present invention, the relay section and communication interface state notification section are realized by a plug-and-play filter.

In the communication control apparatus according to the present invention, the communication interface driver provides a virtual communication interface using a communication system different from another communication system that the communication interface uses, and the first handle supply section has the same configuration as that of the communication interface driver and does not perform control of the communication interface.

In the communication control apparatus according to the present invention, the communication interface is a USB interface, the communication interface driver is a virtual COM port driver that provides the USB interface as a virtual COM port, and the application performs communication using the virtual COM port.

According to a second aspect of the present invention, there is provided a communication control program allowing a computer to execute control of communication between an application executed by the computer and a peripheral device connected to a communication interface of the computer, comprising: a first handle supply step that supplies a first handle that the application uses for communication with the peripheral device to the application; and a relay step that acquires a second handle used for operation of a communication interface driver which is the driver of the communication interface when receiving notification indicating that the peripheral device is connected to the communication interface and, when receiving a request made using the first handle supplied by the first handle supply step from the application, uses the second handle to send the request to the communication interface driver.

The communication control program according to the present invention further comprising, between the first handle supply step and relay step, a communication interface state notification step that notifies that the peripheral device is connected to the communication interface.

In the communication control program according to the present invention, the communication interface state notification step notifies that the peripheral device is disconnected from the communication interface.

In the communication control program according to the present invention, in the case of receiving an access made using the first handle supplied by the first handle supply step after receiving the notification that the peripheral device is disconnected from the communication interface, the rely step notifies the application of an error reply.

In the communication control program according to the present invention, a driver for realizing the first handle supply step and driver for realizing the relay step are resident in the computer, and the communication interface driver and a driver for realizing the communication interface state notification step exist in the computer only while the peripheral device is connected to the communication interface.

In the communication control program according to the present invention, the relay step and communication interface state notification step are realized by a plug-and-play filter.

In the communication control program according to the present invention, the communication interface driver provides a virtual communication interface using a communication system different from another communication system that the communication interface uses, and the first handle supply step has the same configuration as that of the communication interface driver and does not perform control of the communication interface.

In the communication control program according to the present invention, the communication interface is a USB interface, the communication interface driver is a virtual COM port driver that provides the USB interface as a virtual COM port, and the application performs communication using the virtual COM port.

According to a third aspect of the present invention, there is provided a communication driver registration method that registers, in an OS of a computer, a driver for controlling communication between an application executed on the OS and a peripheral device connected to a communication interface of the computer, comprising: a first driver registration step that registers a first handle supply driver and a relay driver in the OS and sets the OS such that the first handle supply driver and relay driver are resident in the computer, the first handle supply driver supplying a first handle that the application uses for communication with the peripheral device to the application, and the relay driver acquiring a second handle used for operation of a communication interface driver which is the driver of the communication interface when receiving notification indicating that the peripheral device is connected to the communication interface and, when receiving a request made using the first handle supplied by the first handle supply driver from the application, using the second handle to send the request to the communication interface driver, and a second driver registration step that registers the communication interface driver in the OS and sets the OS such that it generates the communication interface state notification driver in the computer when the peripheral device is connected to the communication interface.

In the communication driver registration method according to the present invention, the second driver registration step registers in the OS a communication interface state notification driver that notifies the relay driver that the peripheral device is connected to the communication interface and sets the OS such that it generates the communication interface state notification driver in the computer when the peripheral device is connected to the communication interface.

In the communication driver registration method according to the present invention, the relay driver and communication interface state notification driver are realized by a plug-and-play filter.

In the communication driver registration method according to the present invention, the communication interface driver provides a virtual communication interface using a communication system different from another communication system that the communication interface uses, and the first handle supply driver has the same configuration as that of the communication interface driver and does not perform control of the communication interface.

As described above, the present invention allows communication between an application supporting a predetermined connection method and a peripheral device supporting a different connection method from that of the application.

### BRIEF DESCRIPTION OF THE DRAWINGS

FIG. 1 is a block diagram showing a first example of the configuration and operation of a communication system according to the present embodiment;

FIG. 2 is a block diagram showing a second example of the configuration and operation of the communication system according to the present embodiment;

FIG. 3 is a block diagram showing a third example of the configuration and operation of the communication system according to the present embodiment;

FIG. 4 is a block diagram showing a fourth example of the configuration and operation of the communication system according to the present embodiment;

FIG. 5 is a block diagram showing an example of the configuration and operation of a conventional communication system using RS-232C connection; and

FIG. 6 is a block diagram showing an example of the configuration and operation of a conventional communication system using USB connection.

### DETAILED DESCRIPTION OF THE PREFERRED EMBODIMENTS

An embodiment of the present invention will be described below with reference to the accompanying drawings.

In the present embodiment, a communication system in which an information processing apparatus (communication control apparatus (computer)) and a peripheral device communicate with each other will be described.

Firstly, a configuration of the communication system according to the present invention will be described.

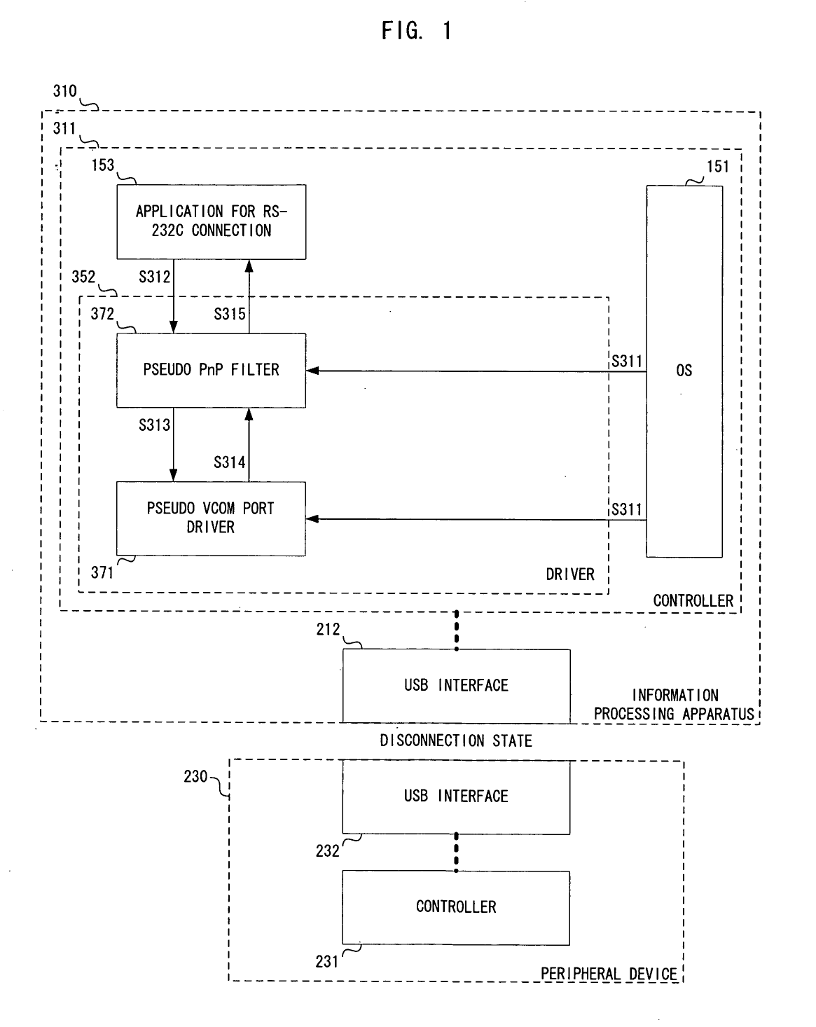

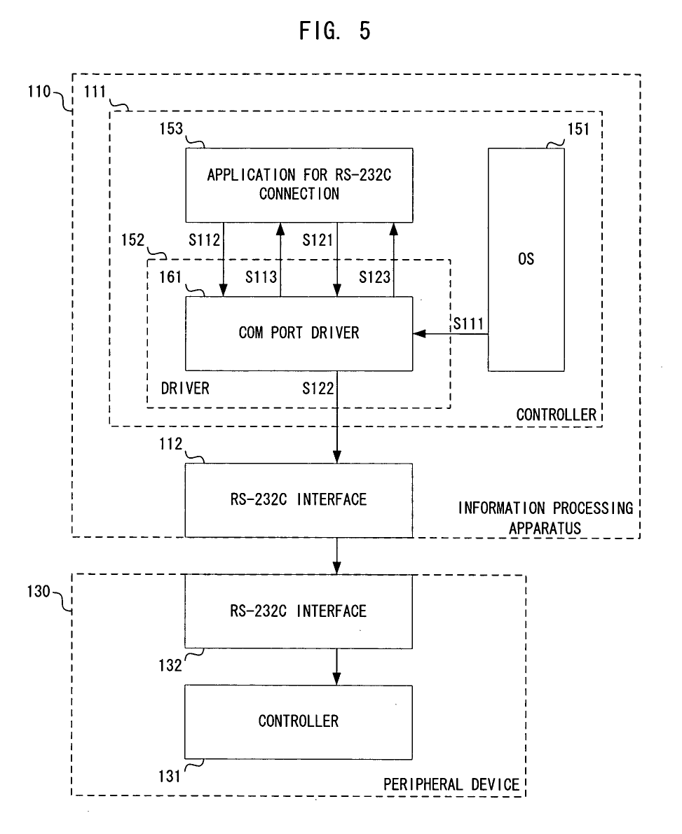

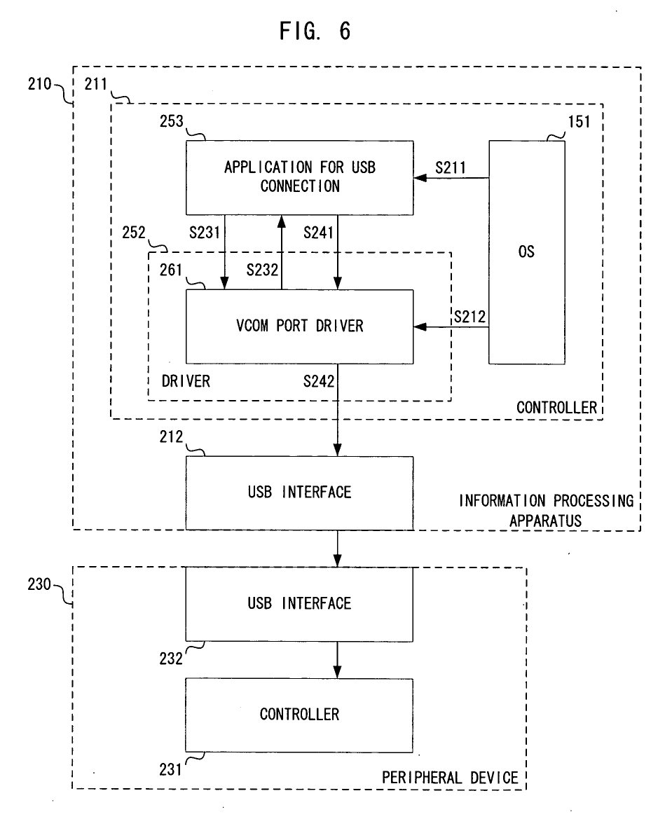

FIG. 1 is a block diagram showing a first example of the configuration and operation of the communication system according to the present embodiment. The communication system shown in FIG. 1 includes an information processing apparatus 310 and a peripheral device 230 (same as one shown in FIG. 6). The information processing apparatus 310 includes, as hardware components, a controller 311 and a USB interface (communication interface) 212 (same as one shown in FIG. 6). The USB interface 212 of the information processing apparatus 310 and USB interface 232 of the peripheral device 230 are connected to each other by a USB cable. In FIG. 1, thick dotted lines denote connection between hardware components. The controller 311 is realized by a CPU and a storage device (memory or the like) like the controller 111 shown in FIG. 5.

The software configuration and operation of the controller 311 in FIG. 1 are those during the startup process of the information processing apparatus 310. The controller 311 includes, as software components, an OS 151 (same as one shown in FIG. 5), a driver 352, and an application for RS-232C connection (same as one shown in FIG. 5). The OS 151 has a plug-and play function. The driver 352 has a pseudo VCOM port driver 371 and a pseudo PnP (plug-and play) filter (driver) 372 during the startup process of the information processing apparatus 310.

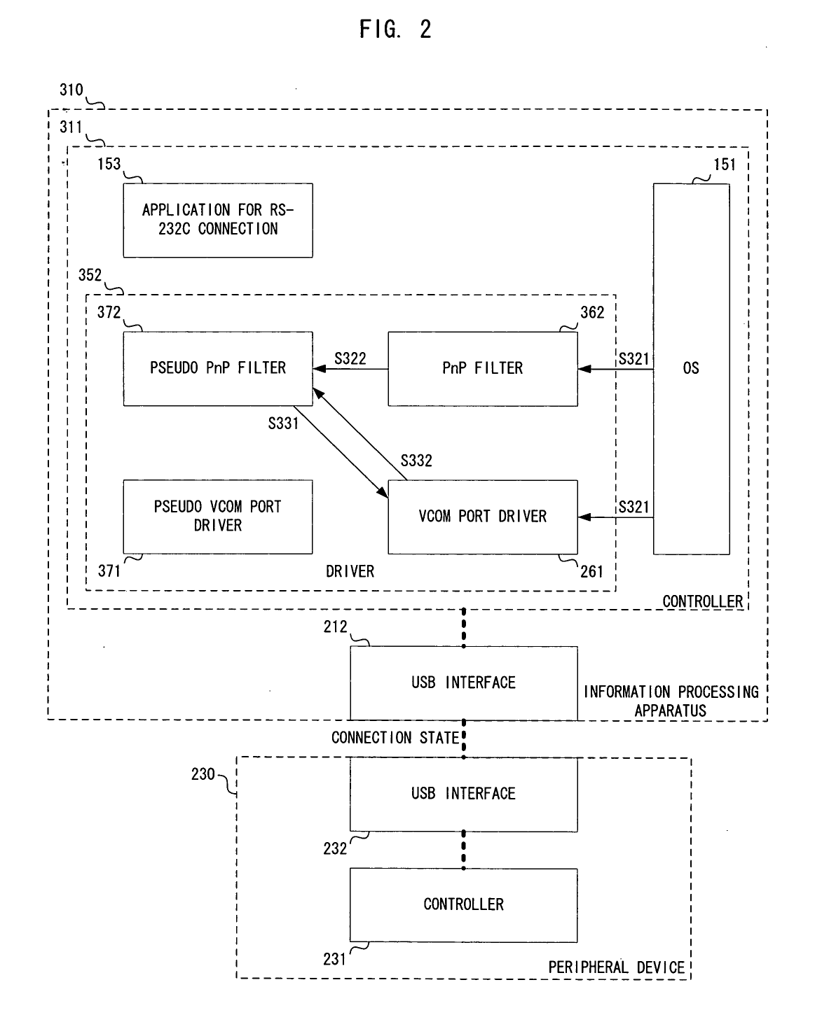

FIG. 2 is a block diagram showing a second example of the configuration and operation of the communication system according to the present embodiment. In FIG. 2, the same reference numerals as those in FIG. 1 denote the same or corresponding parts as those in FIG. 1, and the descriptions thereof will be omitted here. The software configuration and operation of the controller 311 in FIG. 2 are those in a state where the peripheral device 230 is connected to the USB interface 212. In this state, the driver 252 has a VCOM port driver 261 (same as one shown in FIG. 6) and a PnP filter (driver) 362 in addition to the components shown in FIG. 1.

Although the pseudo VCOM port driver 371 is realized by using the same function as that of the VCOM port driver 261, it is resident in the controller 311 simultaneously with the startup process of the OS 151 and does not perform communication using the USB interface 212. The PnP filter 362, which is realized by the function provided by the OS 151 and generated at the generation time of the VCOM port driver 261, communicates with the pseudo PnP filter 372. Although the PnP filter 372 is realized by the same function as that of the PnP filter 362, it is resident in the controller 311 simultaneously with the startup process of the OS 151 and has functions of communicating with the PnP filter 362, relaying communication between the pseudo VCOM port driver 371 or VCOM port driver 261 and application 153, and controlling the VCOM port driver 261.

General operation of this communication system will be described.

The pseudo VCOM port driver 371, pseudo PnP filter 372, VCOM port driver 261, and PnP filter 362 are registered in the OS 151 at the time of installing the driver 352. This registration allows the OS 151 to generate the pseudo VCOM port driver 371 and pseudo PnP filter 372 at its startup process. Further, in this registration, the OS 151 assigns an unused COM port number to the pseudo VCOM port driver 371 as a virtual COM port number. This virtual COM port number, which is a COM port number for communicating with the peripheral device 230, is previously set in the application 153. Further this registration allows the OS 151 to generate the VCOM port driver 261 and PnP filter 362 when the peripheral device 230 is connected to the USB interface 212.

Operation according to the present invention will next be described.

Firstly, a description will be made with reference to FIG. 1. The OS 151 generates the previously registered pseudo VCOM port driver 371 and pseudo PnP filter 372 during its startup process (S311). Afterward, the pseudo VCOM port driver 371 and pseudo PnP filter 372 are resident in the controller 311. The pseudo PnP filter 372 monitors notifications from the PnP filter 362 to recognize whether the peripheral device 230 is connected to the USB interface 212 of the information processing apparatus 310.

Subsequently, the application 153 performs open processing for the pseudo VCOM port driver 371 according to a previously set COM port number during its startup process in the same manner as step S112 (S312, S313) to thereby acquire a pseudo VCOM port control handle from the pseudo VCOM port driver 371 (S314, S315). At this time, the pseudo PnP filter 372 relays communication between the application 153 and pseudo VCOM port driver 371 to thereby retain the pseudo VCOM port control handle.

The description is continued with reference to FIG. 2. When the peripheral device 230 is connected to the USB interface 212, the OS 151 generates the previously registered VCOM port driver 261 and PnP filter 362 (S321). The PnP filter 362 notifies the pseudo PnP filter 372 that the interface state is changed to a connection state (S322). The pseudo PnP filter 372 receives the notification indicating the connection state from the PnP filter 362 and retains the information that the interface state is the connection state. At the same time, the pseudo PnP filter 372 performs open processing for the VCOM port driver 261 (S331) to thereby acquire and retain a VCOM port driver control handle from the VCOM port driver 261 and associates the VCOM port driver control handle with the retained pseudo VCOM port control handle (S332).

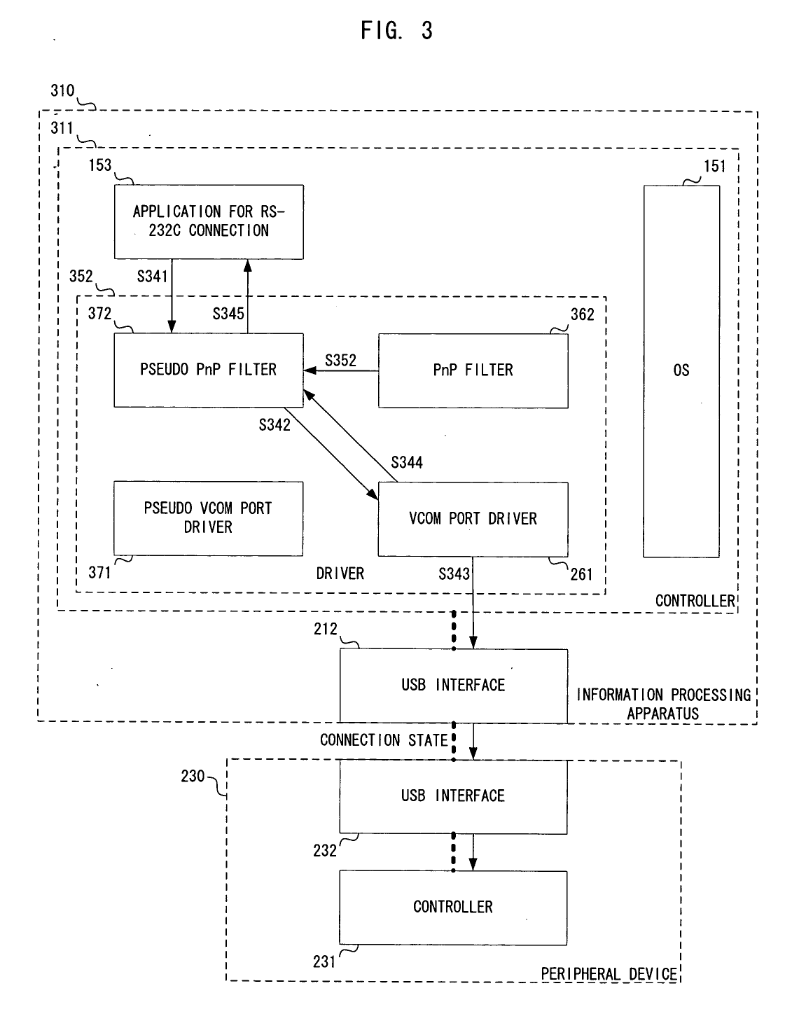

FIG. 3 is a block diagram showing a third example of the configuration and operation of the communication system according to the present embodiment. In FIG. 3, the same reference numerals as those in FIG. 2 denote the same or corresponding parts as those in FIG. 2, and the descriptions thereof will be omitted here. The software configuration and operation of the controller 311 in FIG. 3 are those in a state where the application 153 accesses the peripheral device 230.

Thereafter, while the pseudo PnP filter 372 retains the connection state, the application 153 uses the pseudo VCOM port driver control handle to make an access request (S341). The pseudo PnP filter 372 receives the request and uses a VCOM port driver control handle corresponding to this pseudo VCOM port driver control handle to make an access request (S342). The VCOM port driver 261 receives this request, makes an access to the peripheral device 230 (S343), and notifies the pseudo PnP filter 372 of an access result such as a normal reply or an error reply (S344). The pseudo PnP filter 372 receives the access result and notifies the application 153 of it (S345).

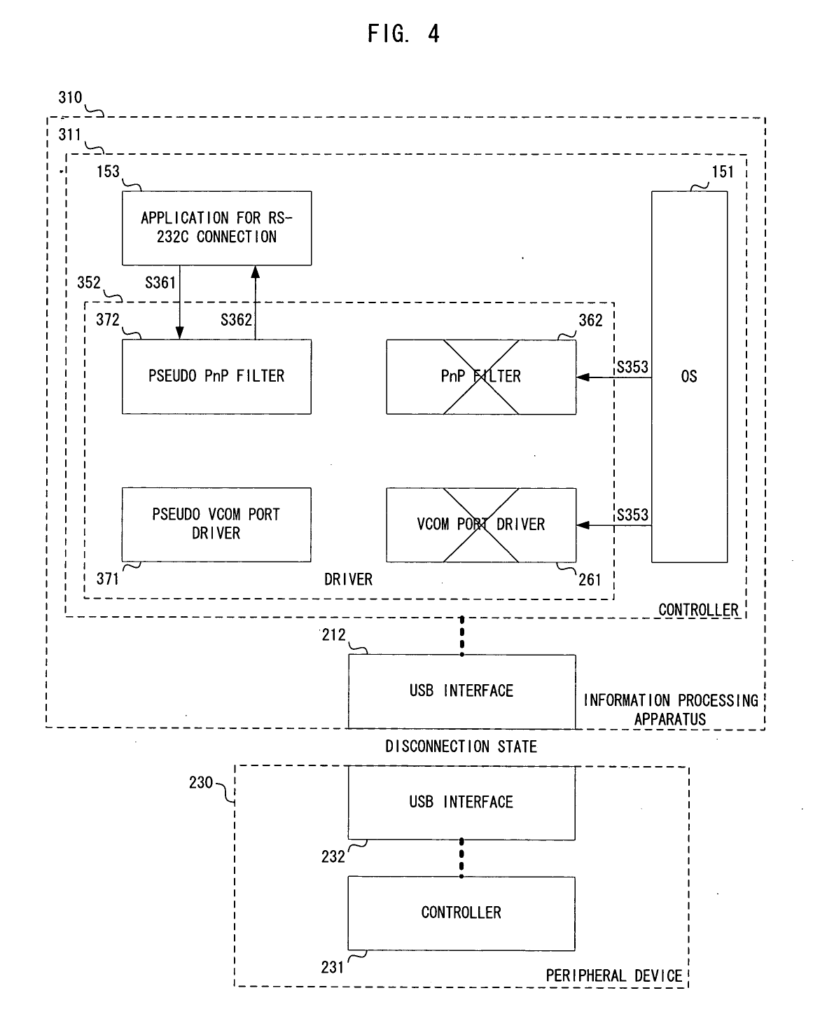

FIG. 4 is a block diagram showing a fourth example of the configuration and operation of the communication system according to the present embodiment. In FIG. 4, the same reference numerals as those in FIG. 2 denote the same or corresponding parts as those in FIG. 2, and the descriptions thereof will be omitted here. The software configuration and operation of the controller 311 in FIG. 3 are those in a state where the peripheral device 230 is disconnected from the USB interface 212.

When the peripheral device 230 is disconnected from the USB interface 212, the PnP filter 362 notifies the pseudo PnP filter 372 that the interface state is changed to a disconnection state (S352 in FIG. 3) and the OS 151 deletes the VCOM port driver 261 and PnP filter 362 (S353). The pseudo PnP filter 372 receives the notification from the PnP filter 362 and retains the information that the interface state is the disconnection state.

Thereafter, while the pseudo PnP filter 372 retains the disconnection state, the application 153 uses the pseudo VCOM port driver control handle to make an access request (S361). The pseudo PnP filter 372 receives the request and notifies the application 153 of an error replay (S362).

According to the present embodiment, the pseudo VCOM port driver 371 is resident in the controller 311 and application 153 performs open processing for the pseudo VCOM port driver 371. This allows the application 153 to continue using the same COM port number and same handle. Further, the pseudo PnP filter 372 relays the open processing performed by the application 153 to the pseudo VCOM port driver 371 and relays the access request made by the application 153 to the VCOM port driver 261. This allows the operation of the VCOM port driver 361 which exists only during a connection state to be made look like operation of the resident pseudo VCOM port driver 371 for the application 153.

With the above configuration, the application 153 for RS-232C connection can communicate with the peripheral device 230 of USB connection type, eliminating the need to modify application resources for RS-232C connection.

Although the application uses RS-232C connection and peripheral device uses USB connection in the above embodiment, the application may use another first connection and peripheral device may use a second connection different from the first connection. In this case, the VCOM port driver and pseudo VCOM port driver allow an interface of the second connection to be treated as an interface of the first connection.

The communication control apparatus according to the present embodiment can easily be applied to the information processing apparatus, further improving the performance of the information processing apparatus. Examples of the information processing apparatus include a POS terminal, a PC (Personal Computer), and a PDA (Personal Digital Assistance).

Further, it is possible to provide a program that allows a computer constituting the communication control apparatus to execute the above steps as a communication control program. By storing the above program in a computer-readable storage medium, it is possible to allow the computer constituting the communication control apparatus to execute the program. The computer-readable medium mentioned here includes: an internal storage device mounted in a computer, such as ROM or RAM, a portable storage medium such as a CD-ROM, a flexible disk, a DVD disk, a magneto-optical disk, or an IC card; a database that holds computer program; another computer and database thereof; and a transmission medium on a network line.

A first handle supply section, a first handle supply step, and a first handle supply driver correspond to the pseudo VCOM port driver mentioned in the embodiment. A relay section, a relay step, and a relay driver correspond to the pseudo PnP filter mentioned in the embodiment. A communication interface driver corresponds to the VCOM port driver mentioned in the embodiment. A communication interface state notification driver, a communication interface state notification step, and a communication interface state notification driver correspond to the PnP filter mentioned in the embodiment.

What is claimed is:

1. A communication control apparatus that is connected to a peripheral device via a communication interface and communicates with the peripheral device, comprising:
a first handle supply section that supplies a first handle that an application running on the communication control apparatus uses for communication with the peripheral device to the application; and
a relay section that acquires a second handle used for operation of a communication interface driver which is the driver of the communication interface when receiving notification indicating that the peripheral device is connected to the communication interface and, when receiving a request made using the first handle supplied by the first handle supply section from the application, uses the second handle to send the request to the communication interface driver.

2. The communication control apparatus according to claim 1, further comprising a communication interface state notification section that notifies the relay section that the peripheral device is connected to the communication interface.

3. The communication control apparatus according to claim 2, wherein
the communication interface state notification section notifies the relay section that the peripheral device is disconnected from the communication interface.

4. The communication control apparatus according to claim 3, wherein
in the case of receiving an access made using the first handle supplied by the first handle supply section after receiving the notification that the peripheral device is disconnected from the communication interface, the rely section notifies the application of an error reply.

5. The communication control apparatus according to claim 2, wherein
the first handle supply section and relay section are resident in the communication control apparatus, and
the communication interface driver and communication interface state notification section exist in the communication control apparatus only while the peripheral device is connected to the communication interface.

6. The communication control apparatus according to claim 2, wherein
the relay section and communication interface state notification section are realized by a plug-and-play filter.

7. The communication control apparatus according to claim 1, wherein
the communication interface driver provides a virtual communication interface using a communication system different from another communication system that the communication interface uses, and
the first handle supply section has the same configuration as that of the communication interface driver and does not perform control of the communication interface.

8. The communication control apparatus according to claim 1, wherein
the communication interface is a USB interface,
the communication interface driver is a virtual COM port driver that provides the USB interface as a virtual COM port, and
the application performs communication using the virtual COM port.

9. A communication control program allowing a computer to execute control of communication between an application executed by the computer and a peripheral device connected to a communication interface of the computer, comprising:
a first handle supply step that supplies a first handle that the application uses for communication with the peripheral device to the application; and
a relay step that acquires a second handle used for operation of a communication interface driver which is the driver of the communication interface when receiving notification indicating that the peripheral device is connected to the communication interface and, when receiving a request made using the first handle supplied by the first handle supply step from the application, uses the second handle to send the request to the communication interface driver.

10. The communication control program according to claim 9, further comprising, between the first handle supply step and relay step, a communication interface state notification step that notifies that the peripheral device is connected to the communication interface.

11. The communication control program according to claim 10, wherein
the communication interface state notification step notifies that the peripheral device is disconnected from the communication interface.

12. The communication control program according to claim 11, wherein
in the case of receiving an access made using the first handle supplied by the first handle supply step after receiving the notification that the peripheral device is disconnected from the communication interface, the rely step notifies the application of an error reply.

13. The communication control program according to claim 10, wherein
a driver for realizing the first handle supply step and driver for realizing the relay step are resident in the computer, and
the communication interface driver and a driver for realizing the communication interface state notification step exist in the computer only while the peripheral device is connected to the communication interface.

14. The communication control program according to claim 10, wherein
the relay step and communication interface state notification step are realized by a plug-and-play filter.

15. The communication control program according to claim 9, wherein
the communication interface driver provides a virtual communication interface using a communication system different from another communication system that the communication interface uses, and
the first handle supply step has the same configuration as that of the communication interface driver and does not perform control of the communication interface.

16. The communication control program according to claim 9, wherein
the communication interface is a USB interface,
the communication interface driver is a virtual COM port driver that provides the USB interface as a virtual COM port, and
the application performs communication using the virtual COM port.

17. A communication driver registration method that registers, in an OS of a computer, a driver for controlling communication between an application executed on the OS and a peripheral device connected to a communication interface of the computer, comprising:
a first driver registration step that registers a first handle supply driver and a relay driver in the OS and sets the OS such that the first handle supply driver and relay driver are resident in the computer, the first handle supply driver supplying a first handle that the application uses for communication with the peripheral device to the application, and the relay driver acquiring a second handle used for operation of a communication interface driver which is the driver of the communication interface when receiving notification indicating that the peripheral device is connected to the communication interface and, when receiving a request made using the first handle supplied by the first handle supply driver from the application, using the second handle to send the request to the communication interface driver, and
a second driver registration step that registers the communication interface driver in the OS and sets the OS such that it generates the communication interface state notification driver in the computer when the peripheral device is connected to the communication interface.

18. The communication driver registration method according to claim 17, wherein
the second driver registration step registers in the OS a communication interface state notification driver that notifies the relay driver that the peripheral device is connected to the communication interface and sets the OS such that it generates the communication interface state notification driver in the computer when the peripheral device is connected to the communication interface.

19. The communication driver registration method according to claim 18, wherein
the relay driver and communication interface state notification driver are realized by a plug-and-play filter.

20. The communication driver registration method according to claim 18, wherein
the communication interface driver provides a virtual communication interface using a communication system different from another communication system that the communication interface uses, and
the first handle supply driver has the same configuration as that of the communication interface driver and does not perform control of the communication interface.
